(19) United States
(12) Patent Application Publication
(10) Pub. No.: US 2013/0027178 A1
(43) Pub. Date: Jan. 31, 2013

(54) CIRCUIT FOR AND METHOD OF IMPLEMENTING A SECODARY IDENTIFICATION CODE IN A GARAGE DOOR OPENER SYSTEM

(71) Applicant: John Joseph King, Wheaton, IL (US)

(72) Inventor: John Joseph King, Wheaton, IL (US)

(21) Appl. No.: 13/193,700

(22) Filed: Jul. 29, 2011

(51) Int. Cl. G05B 19/02

(52) U.S. Cl. 340/5.24

(57) ABSTRACT

A circuit for implementing a secondary identification code stored in a memory associated with a wireless garage door opener keypad unit is disclosed. The circuit comprises a first memory element storing a primary identification code; a second memory element storing a secondary identification code; and a control circuit coupled to receive a disable signal from an input actuator on the wireless garage door opener keypad unit, wherein the control circuit enables and disables the use of the secondary identification code. A method of implementing a secondary identification code is also disclosed.

### FIELD OF THE INVENTION

The present invention relates generally to garage door opener systems, and in particular, to a circuit for and a method of implementing a secondary identification code in a garage door opener system.

### BACKGROUND OF THE INVENTION

Garage door openers provide a convenience to homeowners who would otherwise have to get out of their car to open the garage door. Further, garage doors tend to be heavy, and opening a garage door without the use of a garage door opener may lead to physical injuries. Accordingly, a wireless actuator for a garage door opener was developed. Because the wireless actuator could be kept in the car and locked, it was only necessary that a button of the actuator be pushed to open the door.

While a wireless actuator in a car is useful, a homeowner may need to get into the garage when they are not in the car. For example, a homeowner may be working around the house and need a tool from the garage. If the car is in the garage, or outside of the house but locked, the homeowner may not be able to use the wireless actuator normally kept in the car, and would have to enter the garage using some means.

In order to enable a homeowner to open the garage door without having to use the wireless actuator in their car, a wireless keypad unit was developed to enable a homeowner to access the garage by way of the garage door. The wireless keypad enables a user to enter a code known only to them. Accordingly, a wireless keypad enables access to the garage from outside the house, while limiting the access only to those who know the code. However, conventional wireless keypad units are very limited in their functionality.

### SUMMARY OF THE INVENTION

A circuit for implementing a secondary identification code stored in a memory associated with a wireless garage door opener keypad unit is disclosed. The circuit comprises a first memory element storing a primary identification code; a second memory element storing a secondary identification code; and a control circuit coupled to receive a disable signal from an input actuator on the wireless garage door opener keypad unit, wherein the control circuit enables and disables the use of the secondary identification code.

According to various embodiments, the first memory element and the second memory element may be implemented on the wireless garage door opener keypad unit or on a garage door opener unit. The circuit of may further comprise a visual indicator on the wireless garage door opener keypad unit indicating whether the secondary identification code is enabled or disabled. The input actuator may comprise a numeric keypad and/or a function key. Further, the control circuit may compare a code input by a user with the stored secondary identification code.

According to an alternate embodiment, a circuit for implementing a secondary identification code stored in memory associated with a wireless garage door opener keypad unit comprises a first memory element storing a primary identification code; a second memory element storing a secondary identification code; a keypad adapted to receive entries; and a control circuit coupled to receive the entries on the keypad, the control circuit disabling the use of the secondary identification code, wherein the secondary identification code is retained in the second memory element after disabling the use of the secondary identification code.

The circuit may further comprise a visual indicator on the wireless garage door opener keypad unit indicating whether the secondary identification code is enabled or disabled. The wireless garage door opener keypad unit may further comprise a cover, the visual indicator being visible when the cover is in a closed position. The control circuit may disable the use of the secondary identification code after receiving the primary identification code followed by a numeric sequence on the keypad, or after receiving the primary identification code followed by a selection of a function key. The control circuit may enable programming the secondary identification code after receiving the primary identification code, or erasing the primary identification code.

A method of implementing a secondary identification code stored in a memory associated with a wireless garage door opener keypad unit is also disclosed. The method comprises receiving a primary identification code in response to a first entry on a keypad; storing the primary identification code in a first memory element; receiving a secondary identification code in response to a second entry on the keypad; storing the secondary identification code in a second memory element; receiving a disable signal; and retaining the secondary identification code in the second memory element after receiving the disable signal by way of the input actuator on the wireless garage door opener keypad unit

The method may further comprise detecting whether the secondary identification code is entered on the keypad, and determining whether the secondary identification code is enabled. A garage door opener unit may open a garage door if the secondary identification code is entered on the keypad and the secondary identification code is enabled. The method may further comprise detecting an enable signal entered on the wireless garage door opener keypad unit. The method may further comprise enabling the use of the secondary identification code.

### BRIEF DESCRIPTION OF THE DRAWINGS

FIG. 1 is a block diagram of a garage door opener system according to an embodiment of the present invention;

FIG. 2 is a perspective view of a front panel of a wireless garage door opener keypad unit according to an embodiment of the present invention;

FIG. 3 is a perspective view of a front panel of a wireless garage door opener keypad unit having a visual indicator according to an embodiment of the present invention;

FIG. 4 is a perspective view of a front panel of a wireless garage door opener keypad unit having a program actuator according to an embodiment of the present invention;

FIG. 5 is a perspective view of a front panel of a wireless garage door opener keypad unit having a display according to an embodiment of the present invention;

FIG. 6 is a perspective view of a front panel of a wireless garage door opener keypad unit having a key actuator according to an embodiment of the present invention;

FIG. 7 is a perspective view of a front panel of a wireless garage door opener keypad unit having a plurality of visual indicators according to an embodiment of the present invention;

FIG. 8 is a perspective view of a front panel of a wireless garage door opener keypad unit having a cover according to an embodiment of the present invention;

FIG. 9 is a block diagram of a garage door opener unit according to an embodiment of the present invention;

FIG. 10 is a block diagram of a wireless garage door opener keypad unit according to an embodiment of the present invention;

FIG. 11 is a block diagram of a memory and control circuit of the wireless garage door opener keypad unit according to an embodiment of the present invention;

FIG. 12 is a block diagram of a memory and control circuit of the garage door opener unit according to an embodiment of the present invention;

FIG. 13 is a diagram showing data fields for data transmitted from a wireless garage door opener keypad unit to a garage door opener according to an embodiment of the present invention;

FIG. 14 is a diagram showing data fields for data transmitted from a garage door opener to a wireless garage door opener keypad unit according to an embodiment of the present invention;

FIG. 15 is a flow chart showing a method of implementing a secondary identification code stored in a memory associated with a wireless garage door opener keypad unit according to an embodiment of the present invention;

FIG. 16 is a flow chart showing a method of storing a secondary identification code according to an embodiment of the present invention;

FIG. 17 is a flow chart showing a method of disabling a primary identification code according to an embodiment of the present invention;

FIG. 18 is a flow chart showing a method of enabling a primary identification code according to an embodiment of the present invention; and

FIG. 19 is a flow chart showing a method of erasing a primary identification code according to an embodiment of the present invention.

### DETAILED DESCRIPTION OF THE DRAWINGS

Turning first to FIG. 1, a block diagram of a garage door opener system according to an embodiment of the present invention is shown. The garage door opener system 100 comprises a garage door opener 102 and a wireless garage door opener keypad unit 104 having various input actuators. The garage door opener 102 comprises an antenna 106 coupled to receive data transmitted from the wireless garage door opener keypad unit 104. As will be described in more detail below, a receiver 108 and a controller 110 enable receiving data from the wireless garage door opener keypad unit. A keypad 112, which may comprises a numeric keypad 113 and one or more function keys 114 as will be described in more detail below, enables entering numbers and/or the selection of functions for entering a primary identification code and a secondary identification, enable or disable a secondary identification, or erase a secondary identification code. A control circuit 116 enables the transmission of signals entered on the keypad by way of a transmitter 118 and corresponding antenna 120. A chain 122 coupled to a bracket 124 enable the opening and closing a garage door 126. As will be described in more detail below, the receiver 108 and the transmitter 118 can be transceivers which both transmit and receive signals.

According to the various embodiments of the present invention, a primary identification code is an identification code which is always enabled, and may be entered by performing a program sequence on the keypad after a program button on the garage door opener unit is activated. That is, the primary identification code is preferably not disabled based upon an entry on the keypad alone, but may be changed with input on the garage door opener unit. In contrast, a secondary identification code is entered in response to the entry of a keypad sequence, preferably without interaction with the garage door opener unit. As will be described in more below, the secondary identification code can be enabled, disabled, changed, or erased from the wireless garage door opener keypad unit, and preferable without any need for the user to make a selection on the garage door opener unit.

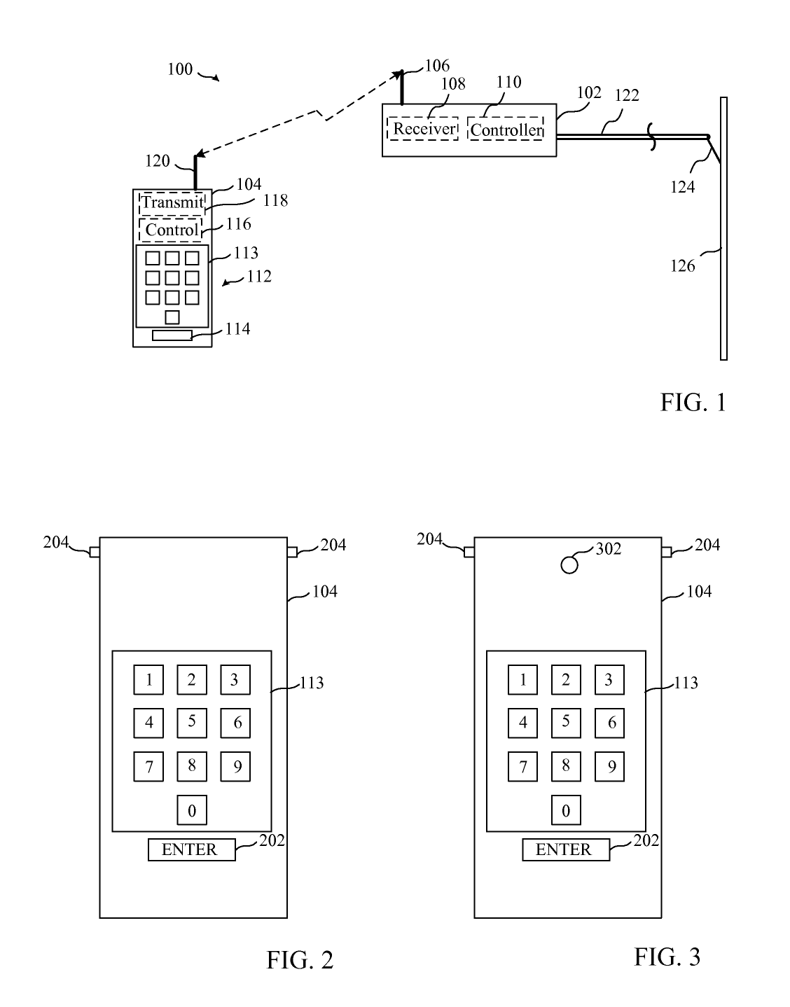

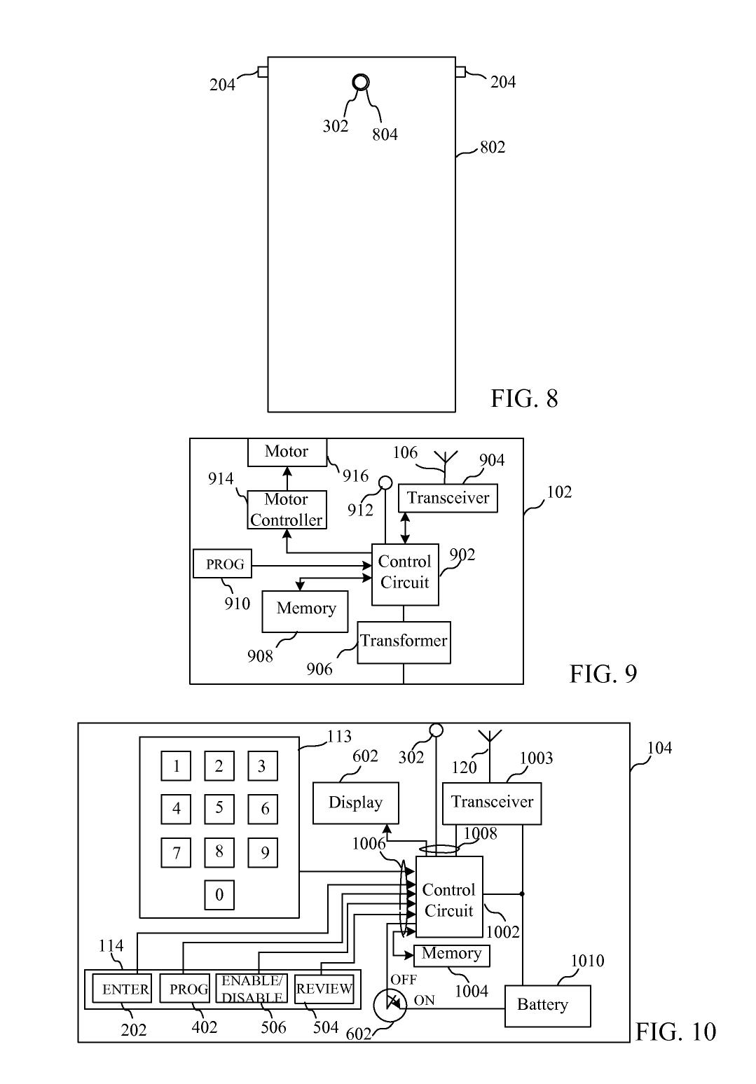

Turning now to FIG. 2, a perspective view of a front panel of a wireless garage door opener keypad unit according to an embodiment of the present invention is shown. As shown in FIG. 2, an enter key 202 comprises a functional key which enables the selection of various features of the wireless garage door opener keypad unit. As will be described in more detail below in reference to the methods of claims 15-19, the enter key may be used to delineate certain functions and enter data for implementing various functions of the wireless garage door opener keypad unit. While other embodiments may have a dedicated program key, the enter key may function not only to enter an identification code, but also to store a secondary identification code, and to enable and disable or erase a secondary identification code, as will be described in more detail below. Prongs 204 extending from the side of the wireless garage door opener keypad unit enable the movement of a cover, as will shown and described in reference to FIG. 8.

The keypad sequence to both enter, enable, disable or erase a secondary identification code are intuitive so that a user can easily implement the various features of the wireless garage door opener keypad unit. After storing a primary identification code, which may be accomplished by entering a desired primary identification code on the wireless garage door opener keypad unit within a predetermined period of time after selecting a program button on a corresponding garage door opener unit, a secondary identification code may be stored in response to an entry on the keypad. For example, a secondary identification may be stored by entering the primary identification code on the keypad, and then entering a desired secondary identification code within a predetermined time period after entering the primary identification code, followed by the selection of the enter function key. While the primary identification code may always be used to open a closed garage door or close an opened garage door, a secondary identification code may be used to open or close the garage door only when the secondary identification code is enabled.

According to one embodiment, a secondary identification code may only be stored if no secondary identification code is currently stored, or after a stored secondary identification code is erased. A stored secondary identification code may be erased by storing a predetermined code, such as “0000” (which would not otherwise be available as a secondary identification code), as the secondary identification code. That is, after storing “0000” as the secondary identification code to effectively erase a currently stored secondary identification code, “0000” would not function as a secondary identification code to either open or close the garage door. Alternatively, a new secondary identification code could be entered and stored over a currently stored secondary identification code by following the sequence to store a secondary identification code. Preferably, the primary identification code could be changed only by interacting with the garage door opener unit, such as the program actuator of the garage door opener unit.

According to various embodiments, a secondary identification code may also be enabled, disabled, erased or reprogrammed using the keypad. For example, after entering the primary identification code, a secondary identification code may be enabled, disabled, erased or reprogrammed by entering of a predetermined code associated with one of the functions, such as a predetermined sequence of keys on the numeric keypad, within a predetermined time after entering the primary identification code and selecting the enter key. In order to make the garage door opener system user friendly, the predetermined sequence of keys for each of the enabling, disabling, erasing or reprogramming sequences is preferably selected to enable a user to easily remember them. For example, a predetermined sequence of keys for enabling a stored secondary identification code may be a “light switch sequence.” That is, the predetermined sequence of keys could be “0-8-5-2” which could easily be remembered by a user as switching on a light switch. Conversely, a predetermined sequence of keys for disabling a stored secondary identification code may be the opposite sequence “2-5-8-0” which could easily be remembered as turning off a light switch. However, it should be understood that a single code could be used for both enabling or disabling the secondary identification code. A predetermined sequence of keys for erasing a stored secondary identification code could be a “0-0-0-0” which could easily be remembered as “zeroing” or erasing the secondary identification code as described above.

Accordingly, any of the predetermined sequences of keys for enabling, disabling or erasing a primary identification code could not be stored as a secondary identification code. Preferably, the entry of the predetermined sequence of keys, or a new secondary identification code, is followed by the enter key change the enable/disable status of a stored secondary identification code or to save the new secondary identification code.

As shown in FIG. 3, a visual indicator 302 comprising a light indicator, such as a light emitting diode (LED) or some other suitable low power lighting element, as implemented to provide a status of a secondary identification code. According to one embodiment, the LED could be a multi-color LED which could indicate different states of the wireless garage door opener keypad unit, and more particularly the different states of the secondary identification code. For example, the LED may be off when no secondary identification code is stored, red when a secondary identification code is stored but disabled, and orange when the secondary identification code is stored and enabled. Alternatively, a single color LED could be used, where different states of a stored secondary identification could be indicated based upon a continuous or one or more flashing states of the LED.

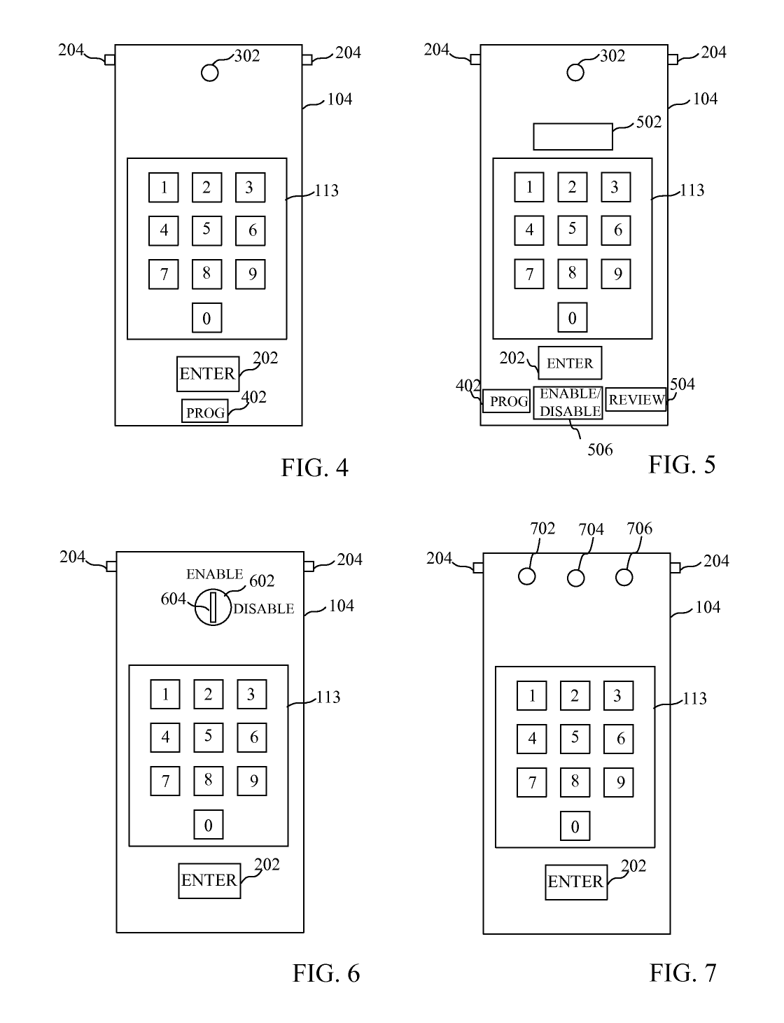

According to the embodiment of FIG. 4, a separate program function key 402 could be used. In particular, a separate program function key may be used for purposes of enabling, disabling, erasing or reprogramming a secondary identification code, where the enter function key would only be used for entering the primary or secondary identification code to open or close a garage door. The use of a program function key may help prevent inadvertently changing a secondary identification or enabling or disabling the secondary identification code when merely trying to open or close the door.

For example, the program key may be used for storing a unique secondary identification code (i.e. a code other than a predetermined enable, disable or erase code). A user may enter an enable or disable code (within a predetermined period of time after entering a primary identification code) followed by the selection of the program function key. Accordingly, the enter function key would only be used to open or close the garage door after successfully entering a primary or secondary identification code.

Turning now to FIG. 5, a perspective view of a front panel of a wireless garage door opener keypad unit having visual indicator comprising a display according to an embodiment of the present invention is shown. In particular, a display 502 enables a user to see information, such as a stored secondary identification code, and the status of the wireless garage door opener keypad unit, such as whether the secondary identification code is enabled or disabled. The information and status may be reviewed in response to the selection of the review function key 504 within a predetermined time after entering the primary identification code. The LED 302 could be employed in conjunction with display 502, where the LED 302 would show the status while the display would provide additional information, such as a currently stored secondary identification code.

According to the embodiment of FIG. 5, a dedicated enable/disable function key 506 could also be implemented. While the enter function key 202 would be used for opening or closing the garage door after the primary identification code or an enabled secondary identification code is entered on the keypad, and the program function key 402 is used for storing identification codes as described above, the enable/disable function key 506 is used for enabling or disabling the secondary identification code. Therefore, it is not necessary to remember a predetermined code for enabling or disabling the secondary identification code. Rather, the user need only select the enable/disable function key 506 within a predetermined period of time after entering the primary identification code. A dedicated enable/disable function key is shown in FIG. 5 by way of example, but could also be employed in other embodiments, such as the embodiments of FIGS. 2-4.

Turning now to FIG. 6, a perspective view of a front panel of a wireless garage door opener keypad unit having a key actuator according to an embodiment of the present invention is shown. More particularly, rather than or in addition to storing a secondary identification code which may be implemented as described in FIGS. 1-4, a key actuator 602 has a slot 604 (which is adapted to receive a unique key) is movable between an enabled and a disabled state, as will be described in more detail below. According to one embodiment, the key actuator 602 would be the only element of the wireless garage door opener keypad unit which is used to enable or disable a secondary identification code. According to another embodiment, the key actuator 602 could be used to enable the use of the keypad for storing or enabling or disabling a secondary identification code. According to a further embodiment, the key actuator 602 could be used in conjunction with the keypad to enable or disable the secondary identification code. That is, if a secondary identification code is enabled, it would be disabled if the key is moved to a disabled position. However, even when the key is in the enabled position, the user could use the keypad to disable the secondary identification code. While FIG. 8 relates to the embodiment of FIG. 3, multiple apertures could be implemented according to the embodiments of FIG. 5 or 7 to expose other visual indicators when the cover is in a closed position. Alternatively, the key could be moved between a locked position and an unlocked position, where a user would only be able to change a setting (such as an enabled or disabled setting) of a secondary identification code.

Turning now to FIG. 7, a perspective view of a front panel of a wireless garage door opener keypad unit having a plurality of visual indicators according to an embodiment of the present invention is shown. As shown in FIG. 7, visual indicators 702-706 enable the use of three secondary identification codes, where each secondary identification code is separately enabled or disabled. The secondary identification codes could be delineated by requiring that the first digit of the first code start with a “1”, the first digit of the second code start with a “2”, and the first digit of the third code start with a “3”. The enabling and disabling of the secondary identification codes could also be implemented using the “light switch” feature, where the key sequences would be based upon the keys below the corresponding visual indicator. More particularly, a first secondary identification code associated with visual indicator 702 would be enabled or disabled based upon key sequences using 1, 4 and 7, a second secondary identification code associated with visual indicator 704 would be enabled or disabled based upon key sequences using 2, 5, 8 and 0, and a third secondary identification code associated with visual indicator 702 would be enabled or disabled based upon key sequences using 3, 6 and 9.

Finally, according to an embodiment of FIG. 8, a cover 802 is used to protect the keypad, function keys and any visual indicators on the wireless garage door opener keypad unit. The cover 802 has an aperture 804 which enables a user to see the visual indicator when the keypad cover is closed. While different features are shown in the different embodiments of FIGS. 2-8, it should be understood that the individual features can be interchanged as desired. For example, the key actuator feature of FIG. 5 and/or the multiple visual indicators of FIG. 7 could be implemented in the embodiment of FIG. 6. While the keypad feature would provide a redundant means for enabling or disabling a secondary identification code, a user may desire both options for enabling or disabling a secondary identification code.

Turning now to FIG. 9, a block diagram of a garage door opener unit according to an embodiment of the present invention is shown. In particular, the garage door opener unit 102 comprises a control circuit 902 coupled to a transceiver 904. A transformer 906 coupled to an alternating current (AC) source to power the control circuit. A memory 908 is coupled to the control circuit. As will be described in more detail below, the memory 908 may be used to store identification codes. A program actuator 910 enables a user to store or change a primary identification code. For example, after selecting the program actuator 910 on the garage door opener unit, a user could enter a primary identification code on the keypad of the wireless garage door opener keypad unit within a predetermined period of time. The garage door opener unit may also comprise an indicator light 912, such as an LED or other suitable light, indicating that the garage door opener unit is in a program mode. Finally, a motor controller 914 is coupled to a motor 916 for opening a garage door.

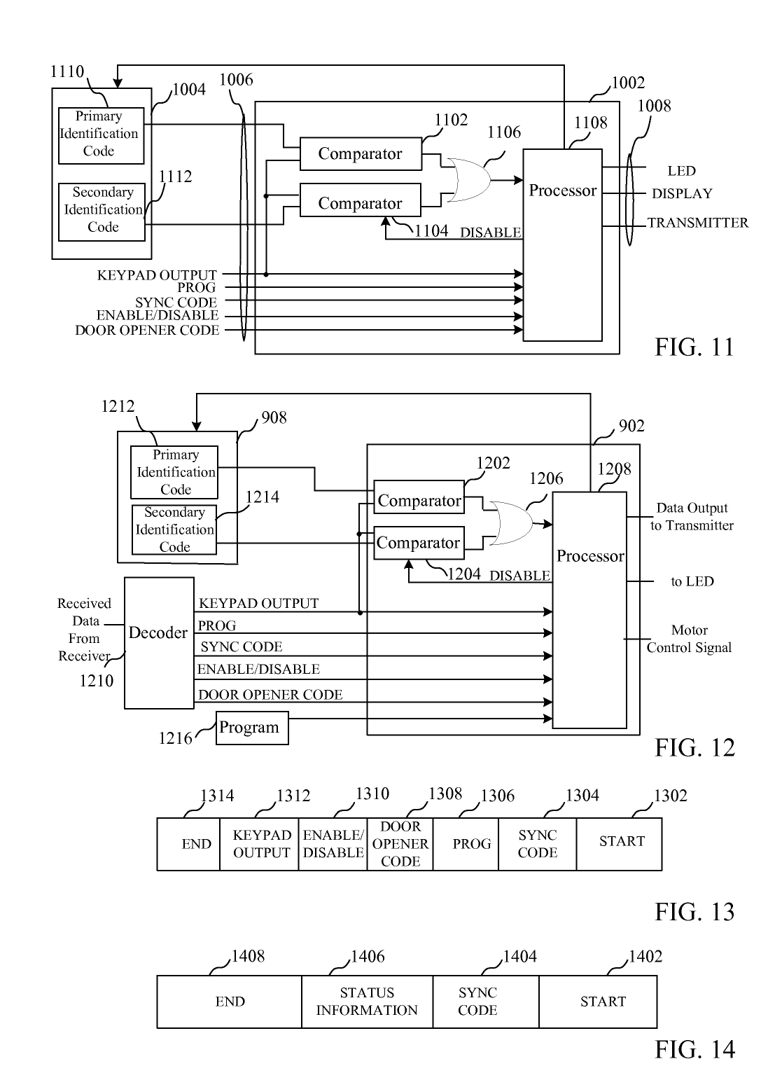

Turning now to FIG. 10, a block diagram of a wireless garage door opener keypad unit according to an embodiment of the present invention is shown. The wireless garage door opener keypad unit 104 comprises a control unit 1002 coupled to a transceiver 1003 and a memory 1004. As will be described in more detail below in reference to FIG. 11, the memory 1004 may be used to store a primary identification code and a secondary identification code. The control circuit receives outputs 1006 of the memory 1004 as well as signals generated in response to user inputs on the numeric keypad 113, the function keys 114 or the key actuator 602, and generates the appropriate outputs 1008 to a visual indicator, such as the LED 302 or the display 602, or to the transceiver 1003.

A block diagram of control circuit 1002 and memory 1004 of the wireless keypad unit is shown in more detail in FIG. 11. The control circuit 1002 comprises a first comparator 1102 and a second comparator 1104 coupled to a logical OR gate 1106, where if either output of the first or second comparator is valid, a signal indicating that a valid primary or secondary identification code has been entered on the keypad is provided to a processor 1108. The processor may be any type of circuit for receiving input data and generating output data in response to the input data. The processor may be a conventional microprocessor, for example. The comparator 1102 is coupled to receive a primary identification code from a memory 1110 and numeric keypad output comprising an identification code entered by a user, while the comparator 1104 is coupled to receive a secondary identification code from a memory 1112 and the numeric keypad output. Assuming that the use of the secondary identification code is enabled, the output of the OR gate will indicate that an identification code matching either the primary identification code or the secondary identification code has been entered. In response, the processor will provide the appropriate door opener code to the transmitter so that is can be sent to the garage door opener.

For example, the door opener code may be a rolling code which is generated by the processor according to a conventional garage door opener standard, such as the Homelink™ garage door opener standard. That is, after initially receiving a door opener code, a series of door opener codes is then generated, both by the wireless garage door opener keypad unit and the garage door opener unit, based upon the initial door opener code. Accordingly, the door opener code will continuously change to avoid detection, but will always be known to both the wireless garage door opener keypad unit and the garage door opener unit.

The processor 1108 is also coupled to receive the keypad output, as well as the outputs of the function keys. If the processor detects that the secondary identification code is disabled in response to entries on the numeric keypad and the function keys as set forth above, the processor will generate a disable signal to the comparator 1104. Accordingly, the processor will not generate the appropriate door opener code if the secondary identification code is entered after the secondary identification code is disabled. The processor will also generate the appropriate signal to the LED or display to indicate that the secondary identification code is disabled. While the embodiment of FIG. 11 shows the comparison function generated by the comparators 1102 and 1104 and the OR gate 1106, the comparison function could also be performed by the processor implementing software enabling the comparison of the stored identification codes and an entered identification code. Further, the memory 1004 could be implemented in cache memory of the processor.

According to the embodiment of FIG. 11, a memory on the wireless garage door opener keypad unit is used to store the values entered on the numeric keypad as primary and secondary identification codes. However, the storage of one or more identification codes and the processing of information entered on the wireless garage door opener keypad unit could be implemented on the garage door opener unit. One benefit of the embodiment of FIG. 11 is that it can be used with any existing garage door opener system operating with a given garage door opener standard. That is, the embodiment of FIG. 11 could be implemented as a replacement handset for an existing system, where the wireless garage door opener keypad unit would determine whether to send a door opener code based upon the status of a secondary identification code.

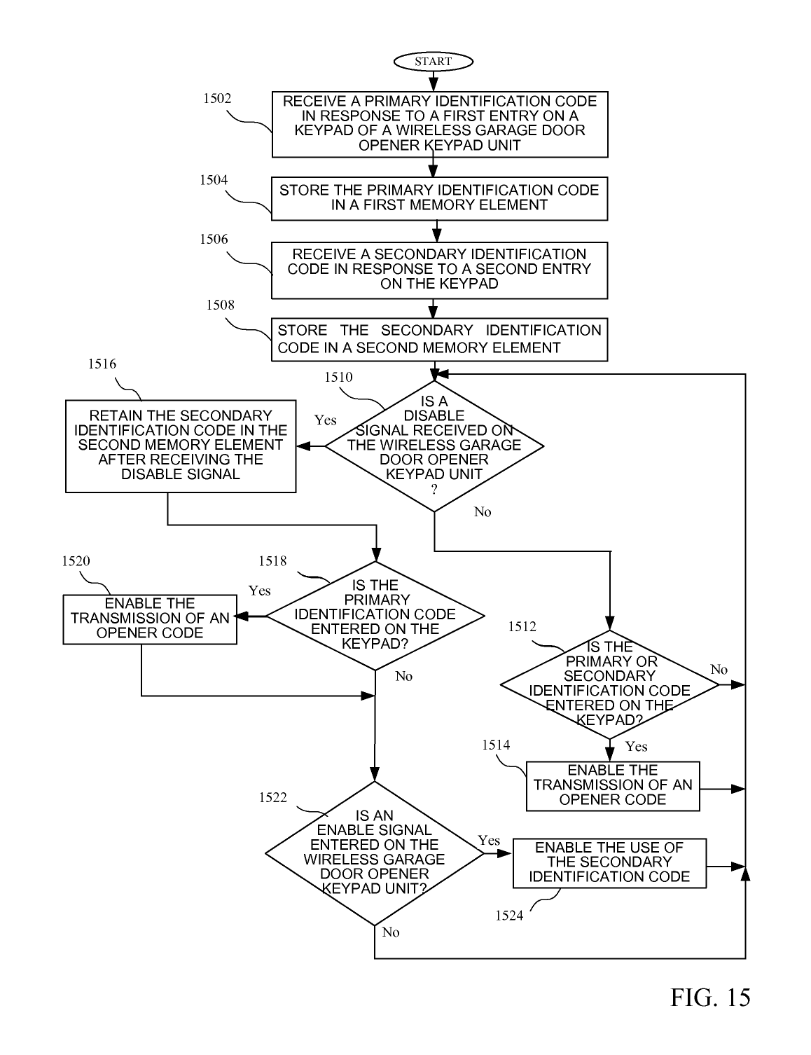

FIG. 12 shows a block diagram of a memory and control circuit of a garage door opener unit according to an embodiment of the present invention. The control circuit 902 and the memory 908 of the garage door opener unit enable the garage door opener unit to determine whether to open the garage door in response to a secondary identification code. The control circuit 902 comprises a first comparator 1202 and a second comparator 1204 coupled to a logical OR gate 1206, where if either output of the first or second comparator is valid, a signal indicating that a valid primary or secondary identification code has been entered on the keypad is provided to a processor 1208 by way of a decoder 1210. That is, the decoder 1210 will decode received data, such as the data received in data fields described in more detail below in reference to FIGS. 13 and 14, from the wireless garage door opener keypad unit. As with the wireless garage door opener keypad unit, the processor of the garage door opener may be any type of circuit for receiving input data and generating output data in response to the input data, such as a conventional microprocessor, for example. The comparator 1202 is coupled to receive a primary identification code from a memory 1212 and numeric keypad output comprising an identification code entered by a user, while the comparator 1204 is coupled to receive a secondary identification code from a memory 1214 and the numeric keypad output. Assuming that the use of the secondary identification code is enabled, the output of the OR gate will indicate that a valid identification code has been entered if either the primary or the secondary identification code has been entered. In response, the processor will enable the garage door opener to open the garage door assuming that the correct door opener is also received.

If the processor detects that the secondary identification code is disabled in response to entries on the numeric keypad and/or the function keys as set forth above, the processor will generate a disable signal to the comparator 1204. Accordingly, the processor will not open the garage door (i.e. generate the appropriate motor control signal) if the secondary identification code had been entered on the keypad. While the embodiment of FIG. 12 also shows the comparison function generated by the comparators 1202 and 1204 and the OR gate 1206, the comparison function could also be performed by the processor 1208 implementing software enabling the comparison of the stored identification codes and the entered identification code. Further, the memory 908 could be implemented in cache memory of the processor 1208. It should be further understood that the processor 1208 and the processor 1108 may enable bidirectional communication by way the transceivers 904 and 1003, respectively. More particularly, in the case where identification codes are stored in the garage door opener unit and the processor of the garage door opener determines if a secondary identification code is enabled, it may be beneficial to send the status of the secondary identification code or any other information which may be reviewed to the wireless garage door opener.

Turning now to FIG. 13, a diagram shows data fields for data transmitted from a wireless garage door opener keypad unit to a garage door opener according to an embodiment of the present invention. More particularly, the data fields according to the embodiment of FIG. 13 comprise a start field 1302, a sync code field 1304, a program field 1306, a door opener code field 1308, an enable/disable field 1310, a keypad output field 1312, and an end field 1314. Data in the start field is used by the processor 1208 to determine that data is about to be sent, while the data in the sync code is used to align the input data to a known point so that the processor can accurately decode the remaining data. The program code in the program field is used to indicate that data in the keypad output field is programming data, such as a secondary identification code. A particular program code may indicate what type of information is being programmed. For example, if an enable or disable function key is used, the program code could indicate that the keypad output is an enable or disable code. Data in the door opener code field is the code necessary to open the garage door. Assuming that the identification code is correctly entered (i.e. either a correct primary identification code or a secondary identification code which is enabled is entered), the door opener code will be sent. Finally, the data in the end field will indicate the end of the data being transmitted.

Turning now to FIG. 14, a diagram shows data fields for data transmitted from a garage door opener to a wireless garage door opener keypad unit according to an embodiment of the present invention. In particular, the data fields which may be sent to the wireless garage door opener keypad unit could include a start code field 1402, a sync code field 1404, a status information field 1406 and an end code field 1408. The status information field could comprise information related to the status of a secondary identification code, for example, or any other information which may be displayed by an LED or on a display. While the fields of FIGS. 13 and 14 are shown by way of example, it should be understood that the various embodiments of the invention could be employed with additional or fewer fields.

Flow charts describing various methods of implementing a garage door opener system having a wireless garage door opener keypad unit are now described. The methods could be implemented using the circuits described in FIGS. 1-14 as described, or using other suitable circuits. While various elements of the methods are shown, additional elements of the methods or additional details of the elements as shown can be found in the description of FIGS. 1-14. Further, the various methods, although shown in different figures for convenience, could be implemented together as desired.

Turning now to FIG. 15, a flow chart shows a method of implementing a secondary identification code stored in a memory associated with a wireless garage door opener keypad unit according to an embodiment of the present invention. According to the various embodiments set forth above, the memory associated with a wireless garage door opener keypad unit could be in either the wireless garage door opener keypad unit or the garage door opener unit. A primary identification code is received in response to a first entry on a keypad of a wireless garage door opener keypad unit at a step 1502, and is stored in a first memory element at a step 1504. A secondary identification code is received in response to a second entry on the keypad at a step 1506, and is stored in a second memory element at a step 1508. It is then determined whether a disable signal received on the wireless garage door opener keypad unit at a step 1510. If not, it is determined whether the primary or secondary identification code entered on the keypad at a step 1512. If so, the transmission of an opener code is enabled at a step 1514.

If a disable signal is received on the wireless garage door opener keypad unit, the secondary identification code is retained in the second memory element after receiving the disable signal at a step 1516. It is then determined whether the primary identification code is entered on the keypad at a step 1518. If so, the transmission of an opener code is enabled at a step 1520. It is then determined whether an enable signal is entered on the wireless garage door opener keypad unit at a step 1522. If so, the use of the secondary identification code is enabled at a step 1524. The keypad is continuously monitored to determine whether an entry is made for performing the various functions as set forth above.

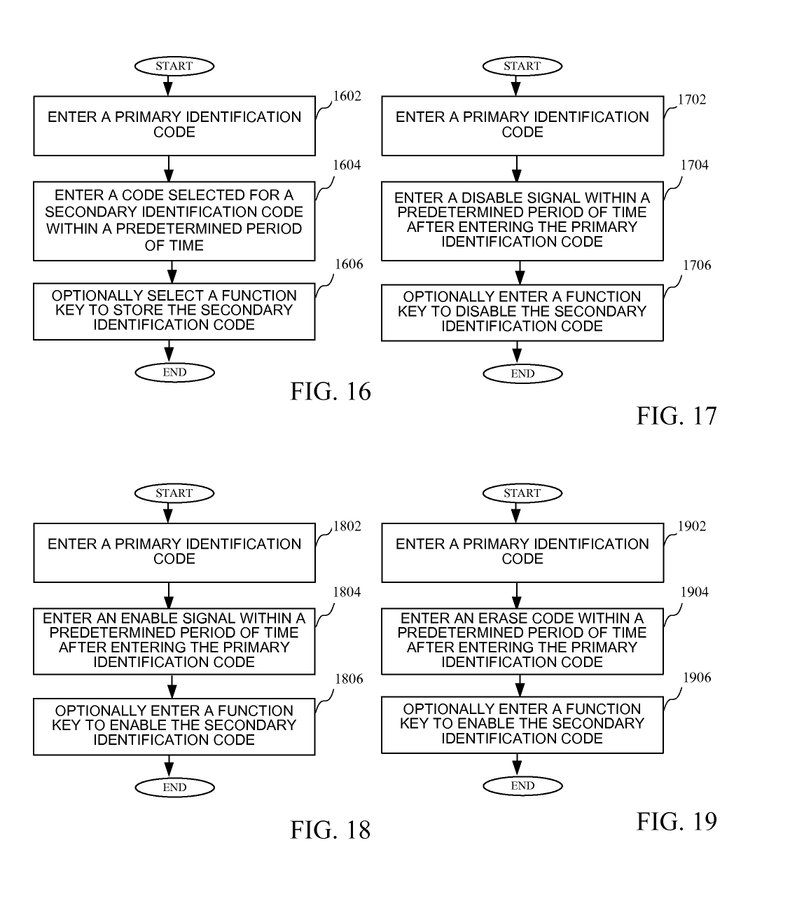

Turning now to FIG. 16, a flow chart shows a method of storing a secondary identification code according to an embodiment of the present invention. A primary identification code is entered at a step 1602. A code selected for a secondary identification code is entered within a predetermined period of time at a step 1604. A function key is optionally selected to store the secondary identification code at a step 1606. As set forth above, the selection key could be the program or enter function keys, for example.

Turning now to FIG. 17, a flow chart shows a method of disabling a primary identification code according to an embodiment of the present invention. A primary identification code is entered at a step 1702. A disable signal is entered within a predetermined period of time after entering the primary identification code at a step 1704. The disable signal may be a predetermined numeric sequence or a dedicated disable function key. A function key is optionally entered to disable the secondary identification code at a step 1706.

Turning now to FIG. 18, a flow chart shows a method of enabling a primary identification code according to an embodiment of the present invention. A primary identification code is entered at a step 1802. An enable signal is entered within a predetermined period of time after entering the primary identification code at a step 1804. The disable signal may be a predetermined numeric sequence or a dedicated disable function key. A function key is optionally entered to enable the secondary identification code at a step 1806.

Turning now to FIG. 19, a flow chart shows a method of erasing a primary identification code according to an embodiment of the present invention. A primary identification code is entered at a step 1902. An erase code, such as “0000” numeric sequence, is entered within a predetermined period of time after entering the primary identification code at a step 1902. A function key is optionally entered to enable the secondary identification code at a step 1902.

It can therefore be appreciated that the new and novel timer and method of implementing a timer has been described. It will be appreciated by those skilled in the art that numerous alternatives and equivalents will be seen to exist which incorporate the disclosed invention. As a result, the invention is not to be limited by the foregoing embodiments, but only by the following claims.

I claim:

1. A circuit for implementing a secondary identification code stored in a memory associated with a wireless garage door opener keypad unit, the circuit comprising:
a first memory element storing a primary identification code;
a second memory element storing a secondary identification code; and
a control circuit coupled to receive a disable signal from an input actuator on the wireless garage door opener keypad unit, wherein the control circuit enables and disables the use of the secondary identification code

2. The circuit of claim 1 wherein the first memory element and the second memory element are implemented on the wireless garage door opener keypad unit.

3. The circuit of claim 1 wherein the first memory element and the second memory element are implemented on a garage door opener unit.

4. The circuit of claim 1 further comprising a visual indicator on the wireless garage door opener keypad unit indicating whether the secondary identification code is enabled or disabled.

5. The circuit of claim 1 wherein the input actuator comprises a numeric keypad.

6. The circuit of claim 1 wherein the input actuator comprises a function key.

7. The circuit of claim 1 wherein the control circuit compares a code input by a user with the stored secondary identification code.

8. A circuit for implementing a secondary identification code stored in memory associated with a wireless garage door opener keypad unit, the circuit comprising:
a first memory element storing a primary identification code;
a second memory element storing a secondary identification code;
a keypad adapted to receive entries; and
a control circuit coupled to receive the entries on the keypad, the control circuit disabling the use of the secondary identification code, wherein the secondary identification code is retained in the second memory element after disabling the use of the secondary identification code.

9. The circuit of claim 8 further comprising a visual indicator on the wireless garage door opener keypad unit indicating whether the secondary identification code is enabled or disabled.

10. The circuit of claim 8 wherein the wireless garage door opener keypad unit comprises a cover, the visual indicator being visible when the cover is in a closed position.

11. The circuit of claim 8 wherein the control circuit disables the use of the secondary identification code after receiving the primary identification code followed by a numeric sequence on the keypad.

12. The circuit of claim 8 wherein the control circuit disables the use of the secondary identification code after receiving the primary identification code followed by a selection of a function key.

13. The circuit of claim 8 wherein the control circuit enables programming the secondary identification code after receiving the primary identification code.

14. The circuit of claim 8 wherein the control circuit enables erasing the primary identification code.

15. A method of implementing a secondary identification code stored in a memory associated with a wireless garage door opener keypad unit, the method comprising:
receiving a primary identification code in response to a first entry on a keypad;
storing the primary identification code in a first memory element;
receiving a secondary identification code in response to a second entry on the keypad;
storing the secondary identification code in a second memory element;
receiving a disable signal; and
retaining the secondary identification code in the second memory element after receiving the disable signal by way of the input actuator on the wireless garage door opener keypad unit.

16. The method of claim 15 further comprising detecting whether the secondary identification code is entered on the keypad.

17. The method of claim 16 further comprising determining whether the secondary identification code is enabled.

18. The method of claim 17, wherein a garage door opener unit opens a garage door if the secondary identification code is entered on the keypad and the secondary identification code is enabled.

19. The method of claim 15 further comprising detecting an enable signal entered on the wireless garage door opener keypad unit.

20. The method of claim 20 further comprising enabling the use of the secondary identification code.
